(19) United States
(12) Patent Application Publication
(10) Pub. No.: US 2015/0135133 A1
(43) Pub. Date: May 14, 2015

(54) ADJUSTABLE SMOOTH SCROLLING

(71) Applicant: Lenovo (Singapore) Pte. Ltd., Singapore (SG)

(72) Inventor: Carlos Munoz-Bustamante, Durham, NC (US)

(73) Assignee: Lenovo (Singapore) Pte. Ltd., Singapore (SG)

(21) Appl. No.: 14/076,731

(22) Filed: Nov. 11, 2013

(51) Int. Cl. G06F 3/0485; G06F 3/01

(52) U.S. Cl. CPC G06F 3/0485; G06F 3/013
USPC 715/785

(57) ABSTRACT

An embodiment provides a method, including: scrolling content rendered in a display device at a first positive speed; receiving, at an optical sensor, image information of a user of an information handling device; determining, using a processor, a focal point of user gaze with respect to the content rendered in the display device, the focal point being derived from the image information; associating the focal point with a target of the display device; adjusting the first positive speed for scrolling of the rendered content to a non-negative second speed based on the associating. Other aspects are described and claimed.

### BACKGROUND

Information handling devices (“devices”), for example laptop computers, tablets, smart phones, e-readers, desktop computers, smart-televisions, etc., may be used to view content in various formats. Such devices for example are often used in a context where users view content on-screen that must be scrolled in some direction. For example, a user may load a web page or text document, e.g., to read or review its contents, onto a display device/screen. If the content does not all fit within one display screen, the user must scroll or reposition the content in order to view it.

Therefore, due to the nature of content and/or the physical dimensions of the device displays, the user ends up repositioning or scrolling the content on the display screen. This is quite common in devices that have smaller display screens, e.g., smart phones and tablets. To scroll the content, the user often must provide manual inputs, e.g., via a touch screen, mouse or keyboard input, to reposition the content on the display. Depending on the content and/or the physical dimensions of the device, a user may need to make many scrolling movements.

### BRIEF SUMMARY

In summary, one aspect provides an information handling device, comprising: an optical sensor; a display device; a processor; and a memory device storing instructions executable by the processor to: scroll content rendered in the display device at a first positive speed; receive, at the optical sensor, image information of a user of an information handling device; determine a focal point of user gaze with respect to the content rendered in the display device, the focal point being derived from the image information; associate the focal point with a target of the display device; adjust the first positive speed for scrolling of the rendered content to a non-negative second speed based on the associating; and activate a second target.

Another aspect provides a method, comprising: scrolling content rendered in a display device at a first positive speed; receiving, at an optical sensor, image information of a user of an information handling device; determining, using a processor, a focal point of user gaze with respect to the content rendered in the display device, the focal point being derived from the image information; associating the focal point with a target of the display device; adjusting the first positive speed for scrolling of the rendered content to a non-negative second speed based on the associating; and activating a second target.

Another aspect provides a method, comprising: scrolling content rendered in a display device at a first positive speed; receiving, at an optical sensor, image information of a user of an information handling device; determining, using a processor, a focal point of user gaze with respect to the content rendered in the display device, the focal point being derived from the image information; and adjusting the first positive speed for scrolling of the rendered content to a non-negative second speed based on the focal point of user gaze within the content rendered in the display device; wherein the non-negative second speed is zero when the focal point exceeds a predetermined distance from a target.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example method of adjustable smooth scrolling using gaze tracking.

FIG. 4 illustrates another example method of adjustable smooth scrolling using gaze tracking.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Requiring a user to manually reposition the content rendered within a display device is a common technique. However, given that device displays are sometimes quite small, e.g., for a smart phone or tablet device, etc., and/or the content rendered is formatted such that scrolling is appropriate, e.g., longer text documents, various approaches have been developed in an attempt to implement automated or assisted scrolling.

One example of assisted scrolling includes permitting a user to provide a manual input, e.g., to a mouse scroll wheel or via a menu selection, and thereafter provide small manual inputs, e.g., in the form of small up and back movements via a mouse, to scroll through the rendered content. However, this requires the user to both provide manual inputs to enter an assisted scrolling mode and provide manual inputs for controlling the assisted scrolling mode.

Accordingly, an embodiment provides assisted scrolling that is smoothed or adjusted based on a user's focal point within the rendered content, e.g., as referenced to a target position or location. An embodiment employs gaze tracking to determine where within a display screen's rendering a user is looking, i.e., his or her focal point, and adjusts the speed of scrolling accordingly. This provides the user with the desired content on screen and does not burden the user with requirements for manual inputs or the like. Moreover, the user, being able to adjust the scrolling speed intuitively, will not need to provide corrective input due to a scrolling speed that is not adjustable, as found in conventional approaches.

It should be noted herein that scrolling of content rendered on a display device takes the meaning of repositioning of rendered content on the display. The speed at which the content is repositioned is referred to herein as a scrolling speed. A positive scrolling speed takes the meaning of scrolling to reveal new content, e.g., commonly understood as “downward” scrolling, with the understanding that many devices may be re-oriented such that downward is a relative term with respect to revealing new content. A negative scrolling speed, on the other hand, takes the meaning of repositioning rendered content to display previously viewed content, e.g., commonly understood as “upward” scrolling.

The illustrated example embodiments will be best understood by reference to the figures. The following description is intended only by way of example, and simply illustrates certain example embodiments.

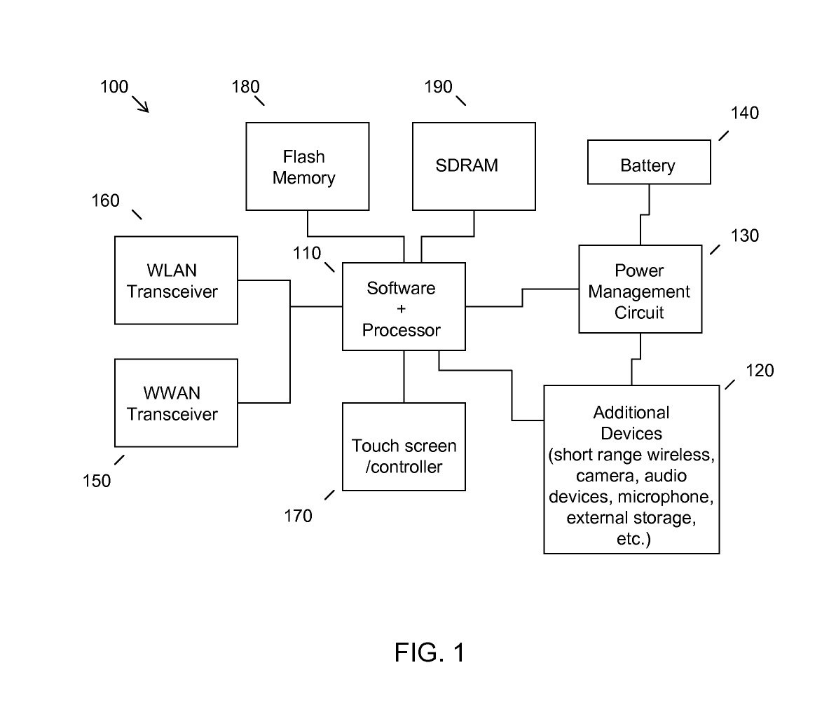

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a camera, which may include two or more cameras (e.g., forward and backward looking cameras). Commonly, system 100 will include a touch screen 170 for data input and display/rendering. System 100 also typically includes various memory devices, for example flash memory 180 and SDRAM 190.

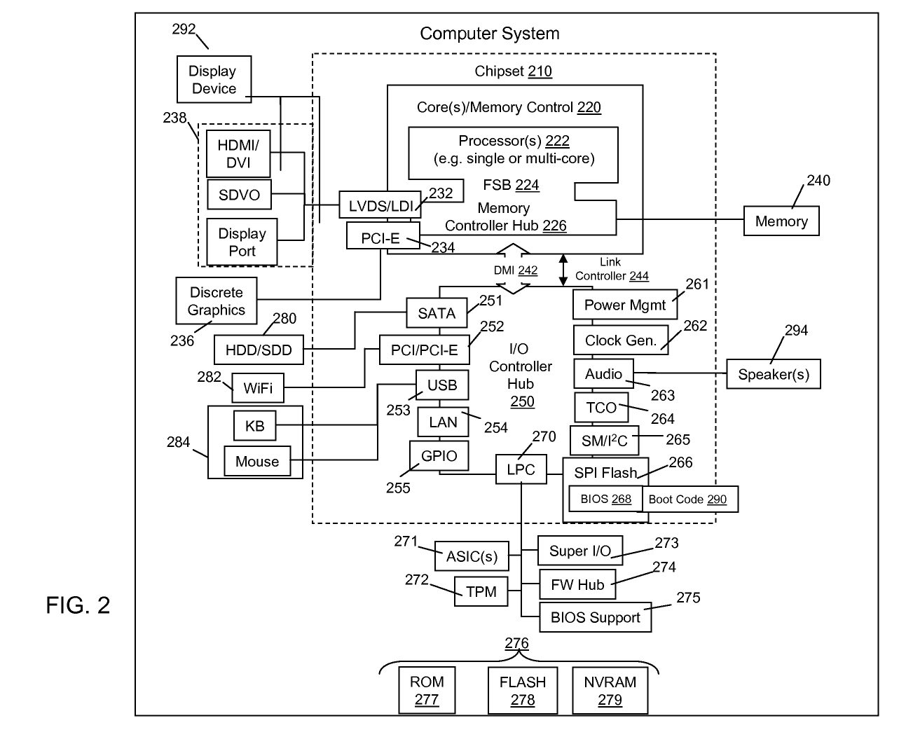

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices that implement the smoothed or adjusted scrolling described herein. For example, either of the device circuitry outlined in FIG. 1 or the device circuitry outlined in FIG. 2 may render content on a display device, e.g., touch screen or LCD panel. A user may scroll the rendered content via any conventional technique, e.g., manually interfacing with the touch screen, providing mouse or keyboard inputs to scroll content on a separate display, etc., in addition to the smooth scrolling described herein.

According to an embodiment, a user may scroll content rendered in a display device to reposition the content by simply looking to a different area of the content as it is rendered in the display device. For example, a camera or other optical sensor of a device tracks the user's eye movements, which are analyzed to determine a focal point, e.g., utilizing gaze tracking software. Eye tracking systems and associated software for an efficient determination of a user's focal point, i.e., a gaze position against the display device, are utilized in other contexts, e.g., marketing and psychological research among others. An example gaze tracking or eye tracking system and software is the FACELAB system available from SEEING MACHINES. FACELAB is an unregistered trademark of Seeing Machines Limited in the United States and other countries. SEEING MACHINES is a registered trademark of Seeing Machines Limited in the United States and other countries.

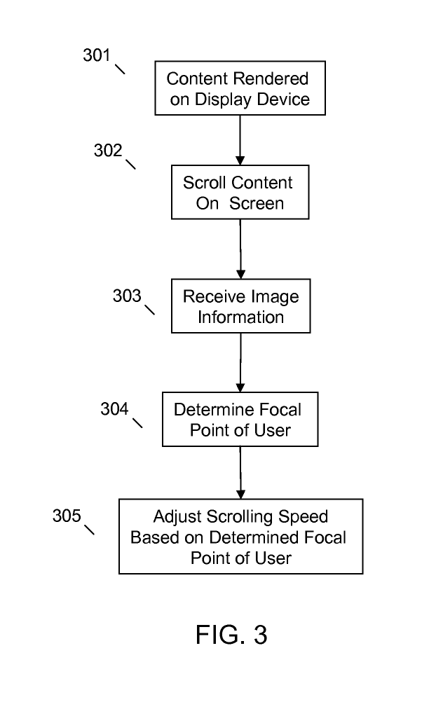

Referring to FIG. 3, with the ability to determine a user's focal point or gaze position against a display device, an embodiment utilizes this to adjust or smooth scrolling of on-screen content. An embodiment renders content on a screen or a display device at 301. This content may include content of a variety of formats, e.g., a web page rendered in a browser, a word processing document rendered in a word processing application, etc. The content, as described herein, may not fit into the amount of display device available. For example, for a web page or a word processing document, a user may need to scroll downward in a positive direction to read or view material not yet displayed.

An embodiment may scroll content, e.g., via manual input of the user according to a conventional scrolling technique, or an embodiment may implement assisted scrolling for the user in a default assisted or automated scrolling mode at 302. For example, a default automated scrolling speed may be employed. Likewise, a user may select a preferred scrolling speed or the default speed may be adjusted based on a user history. For example, the speed of scrolling implemented at 302 may be dependent on the user's previous interaction with the device. Moreover, the scrolling implemented at 302 may be a continuation of assisted or smooth scrolling based on a user's focal point as determined through gaze tracking, as further described herein. Additionally or in the alternative, an embodiment may employ a default or initial scrolling speed based on a factor or factors such as a type of content rendered, an application used to render the content, a user selection, a user history, and a device characteristic.

At 303 an embodiment receives image input, e.g., in the form of visible image information derived from a frontward looking camera (noting that this is a non-limiting example). The term image information is used herein as an example given that the raw or unaltered image captured by a camera may undergo processing prior to being analyzed by a gaze tracking software module.

Given the image information at 303, an embodiment may utilize gaze tracking to determine a user's focal point on screen at 304. For example, by analyzing the image information (which may include a series of images or a stream of image inputs) an embodiment may determine the user's eye location and map this to an area of the display device. Thus, an embodiment may determine, using the user's focal point derived from a camera capturing an image(s) of the user's eyes, where in the display device the user is looking at 304. Depending on the accuracy desired, this determination may be refined to a small sub-area of the display device (e.g., the area of the display used to render a single word) or to a larger sub-area (e.g., top-third, middle-third, lower-third, upper margin or edge, lower margin or edge, etc.).

Given the location of the user's focal point in the display device, an embodiment may adjust or smoothen the scrolling speed at 305. For example, an embodiment may increase the scrolling speed, decrease the scrolling speed, or pause the scrolling (no or zero speed) based on the determined location of the user's focal point.

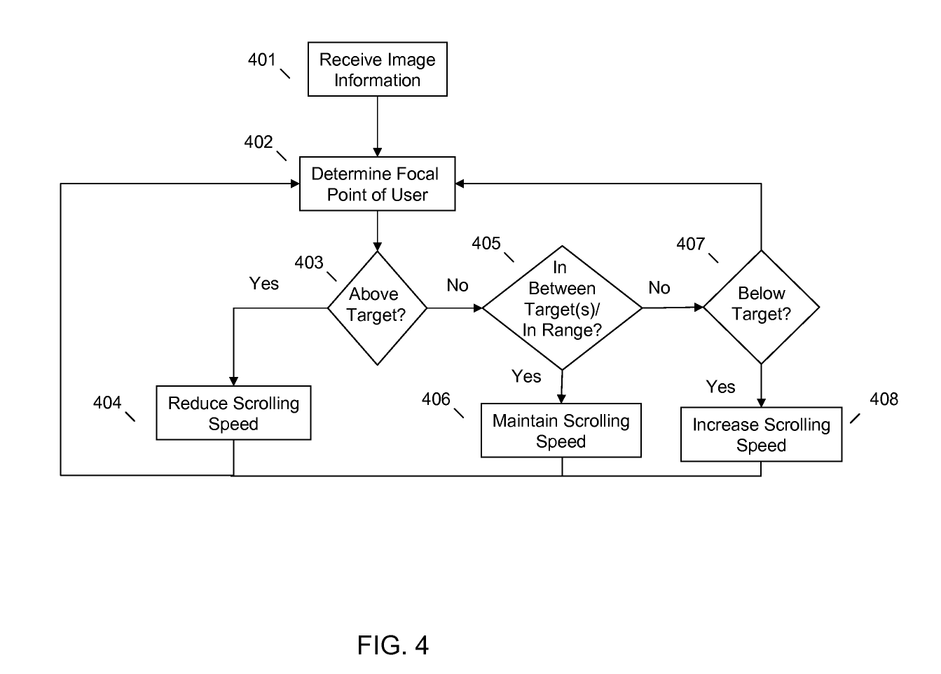

For example, referring to FIG. 4, an embodiment may divide the display into sub-areas or provide a target or targets to create reference point(s) for adjusting or smoothing the scrolling speed. In the example of FIG. 4, an embodiment receives image information at 401 and utilizes it to determine a user's focal point at 402, e.g., as described in connection with FIG. 3. In determining the user's focal point at 402, an embodiment may map the focal point into one of a set of pre-defined sub-areas of locations or associated it with a target within the display device, e.g., determine a distance between the user's focal point and the target(s). Each of the pre-defined sub-areas or target(s) may be associated with a corresponding functionality regarding the adjustment of the scrolling speed.

An embodiment may implement a target such as a line target, e.g., corresponding to a horizontal line across the display device. This target may not be literally displayed. The target may be mapped to a physical characteristic of the device (e.g., line or lines of pixels). The target may act as a reference point with respect to a user's focal point. The distance between the target and the user's focal point, if any, may be utilized to adjust the scrolling of content. For example, as the user's focal point drops below a target, an embodiment may increase the scrolling speed. The scrolling speed may be adjusted or modified, e.g., increased or decreased, based on the distance, e.g., proportionally. Moreover, exceeding a predetermined distance (between the user's focal point and a target) may activate a pause of scrolling. More than one target may be utilized at a given time, e.g., an upper target and a lower target may both be utilized.

As one example, if an embodiment determines at 403 that the user's focal point is currently above a target of the display device, this may result in the reduction of the scrolling speed at 404 to a second positive scrolling speed. Thus, while a positive (i.e., downward) scrolling speed is maintained, it may be reduced from the previous (first) speed by an amount. The amount of reduction may be determined in a variety of ways. For example, a user may select an amount of reduction, an embodiment may learn the amount of reduction, e.g., via consulting a stored history of user interactions, and/or an embodiment may dynamically adjust the amount of reduction, e.g., based on the distance from the target and/or via iterating through steps 401-402 with gradual reduction in scrolling speed until it is determined that the user's gaze is not located above the target of the display.

If an embodiment determines that the user's gaze or focal point is not above the target of the display device but rather determines at 405 that the user's focal point is located in-between a top target and a bottom target and/or located within a predetermined distance or range of a single target (e.g., in a middle sub-area of the display device), the scrolling speed may be maintained or remain constant. For example, an embodiment may determine that the current scrolling speed (which may be a default scrolling speed, a user selected scrolling speed, or a previously adjusted/dynamically adjusted scrolling speed, etc.) is appropriate given that the user is focused near the middle area of the display device. Accordingly, no adjustment to the scrolling is required and the scrolling speed may be maintained at 406.

Similarly, an embodiment may determine that the user's focal point is located below a target of the display device, e.g., below a lower target of the display device, at 407. In this circumstance, an embodiment may increase the scrolling speed in order to bring new content into the display at 408 at an increased rate. This will also tend to shift the user's focal point back up the display device towards the middle of the rendered content in order to view the new material as it scrolls up the screen at an increased speed.

As described herein, an embodiment provides for the automated adjustment of a scrolling speed using gaze tracking. An embodiment uses a current focal point of the user to determine if the current scrolling speed is appropriate and to make adjustments thereto. Thus, at least one embodiment strives to maintain an equilibrium or balance in the scrolling speed such that the user's focal point remains relatively stable and in a central portion of the screen.

In an embodiment, a target (or targets) may be adjusted. For example, a target may be relocated based on a variety of parameters including but not limited to the content type being rendered, the type of application containing the content being rendered, display or device type, user feedback (e.g., input or inferred), etc. The adjustment or modification of a target may include activating a second target to relocate the previous target and/or to implement an additional target (e.g., two or more targets).

An embodiment may therefore adjust the target or equilibrium point for the user's gaze or focal point, may adjust the scrolling speed, and/or pause functionality depending on the context encountered. For example, a user may wish to have the target or equilibrium point adjusted given the current scrolling speed, the context of the rendering (e.g., application type) or the actual content being rendered, etc. Thus, an embodiment may adjust the scrolling speed depending on the context encountered, e.g., based on content type, the application type, device type and the like.

For example, in one context, e.g., a document containing technical materials (e.g., content type as ascertained via key word and/or character analysis of the underlying document), an embodiment may slow the scrolling speed based on the underlying content, may adjust the equilibrium point or target, and/or may adjust the pausing of the scrolling. Similarly, for a user reading a non-technical document, e.g., a novel, as ascertained for example by application type, device type (e.g., e-reader), word and/or character content, file name, etc., if the user looks upward to the top of the screen (e.g., as ascertained by the distance between the user's focal point and a target), an embodiment may pause scrolling, whereas a user looking abruptly down in this content may have the scrolling speed adjusted upward (i.e., faster scrolling speed, page skipping, etc.). Therefore, differential handling of the scrolling speed adjustment may take into account not only the user's focal point and changes with reference to target(s), but also based on the context (e.g., document type, content (including the presence of image(s) or tabular data), device type, etc.).

An embodiment therefore may adjust the scrolling speed based on a factor or factors such as a distance from the target, a type of content rendered, an application used to render the content, a user selection, a user history, and a device characteristic. For example, proportional increases or decreases of scrolling speed based on distance may be modified or further adjusted based on a type of content rendered, an application used to render the content, a user selection, a user history, a device characteristic, etc.

The target(s) may be used to effectively divide the content rendering into sub-areas. The division of the screen into sub-areas, and the particular sub-areas referenced above, may be modified (e.g., via activation/modification of target(s)) to fit a given context. For example, where the user is consuming a text-dense word processing document, the upper, middle and lower sub-areas may be utilized. Nonetheless, in addition to these, extreme upper and lower sub-areas may be utilized. For example, an extreme upper edge or lower edge of the display may be included as a sub-area and have corresponding functionality associated therewith. For example, if a user looks at or creates a focal point on the extreme top or upper margin of the display device, the scrolling speed may be reduced significantly or reduced completely (i.e., paused). Likewise, if a user looks to the extreme lower margin or edge of the display device, an embodiment may increase the scrolling speed or implement skipping (e.g., page skipping) to bring new content on screen more quickly.

The content of the display rendering may also inform the speed at which scrolling is adjusted. For example, in an image heavy document or in a document where horizontal scrolling may be appropriate, the sub-division or sub-areas may include lateral areas of the display screen, for scrolling left and/or right or for modifying the positive scrolling speed. Thus, a user's eye movements in lateral direction (e.g., left or right) may be used to determine appropriate sub-areas for use in the context of the example method illustrated in FIG. 4.

An embodiment may filter or analyze eye movement of the user to distinguish eye movement types. For example, an embodiment may distinguish reading eye movement (e.g., characterized by lateral eye movement followed by a small vertical eye movement downward) from other eye movements, e.g., fast up or down eye movements. Based on eye movement type, an embodiment may implement different adjustments to the scrolling speed, including pausing. Thus, an embodiment may disregard certain eye movements, e.g., abrupt eye movements, and not adjust the scrolling speed, may utilize such eye movements to implement a pause, and may likewise utilize reading eye movements to adjust smooth scrolling.

Additionally or in the alternative, lateral eye movements may be used to inform the decision regarding adjusting scrolling speed directly. For example, if a user looks laterally, this may be an indication that the user is reviewing a certain line of text or image rendered on screen. This may be used to adjust the scrolling speed, e.g., downward or to a pause. Accordingly, either or both of upward/downward eye movements and lateral eye movements (including angles there-between) may be utilized by an embodiment to adjust the scrolling speed.

It will be noted that the point at which the user's focus is maintained may be adjustable depending on how much new content the user wishes to view in a given rendering. That is, if the scrolling speed is increased, new content will come up on the screen more quickly. In contrast, if the scrolling speed is reduced, new content will take longer to populate the screen. The rate at which new content is presented may be adjusted based on where the equilibrium point or sub-area is set for implementing adjustment to the scrolling speed. For example, if a user wishes to have the screen dominated by new content, an equilibrium point nearer the top of the screen may be chosen. Again, the point at which the user's focus is adjusted may be refined by the user, e.g., manually via settings, may be refined dynamically, e.g., in response to previous adjustments or as leaned through the user's movement or focal point over time, or some suitable combination of the foregoing.

Therefore, embodiments permit the user to adjust a scrolling speed using an intuitive method wherein a focal point is leveraged to smoothen the scrolling to match the user's actual consumption of on screen content. This avoids requiring the user to provide manual inputs and allows for more convenient and intuitive control of on screen content movement.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable storage medium(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An information handling device, comprising:
an optical sensor;
a display device;
a processor; and
a memory device storing instructions executable by the processor to:
scroll content rendered in the display device at a first positive speed;
receive, at the optical sensor, image information of a user of an information handling device;
determine a focal point of user gaze with respect to the content rendered in the display device, the focal point being derived from the image information;
associate the focal point with a target of the display device;
adjust the first positive speed for scrolling of the rendered content to a non-negative second speed based on the associating; and
activate a second target.

2. A method, comprising:
scrolling content rendered in a display device at a first positive speed;
receiving, at an optical sensor, image information of a user of an information handling device;
determining, using a processor, a focal point of user gaze with respect to the content rendered in the display device, the focal point being derived from the image information;
associating the focal point with a target of the display device;
adjusting the first positive speed for scrolling of the rendered content to a non-negative second speed based on the associating; and
activating a second target.

3. The method of claim 2, further comprising determining a distance between the focal point and the target.

4. The method of claim 3, wherein the adjusting is proportional to the distance.

5. The method of claim 3, wherein the activating is triggered based on the distance.

6. The method of claim 2, wherein the target and the second target are both maintained and utilized for the adjusting.

7. The method of claim 2, wherein the target is replaced by the second target following activation of the second target.

8. The method of claim 2, wherein the non-negative second speed is larger than the first positive speed and results in an increased downward scrolling speed.

9. The method of claim 2, wherein the target comprises a horizontal sub area of the display.

10. The method of claim 9, wherein the target is not displayed in the display device.

11. The method of claim 9, wherein the target is located in an upper third of the display device.

12. The method of claim 11, wherein the second target is located in a lower third of the display device.

13. The method of claim 12, wherein:
the target and the second target bound a middle area of the display device; and
smooth scrolling is implemented via the adjusting based on a distance between a current focal point of the user and one or more of the target and the second target.

14. The method of claim 2, wherein scrolling initially proceeds at a default rate determined via a factor selected from the group of factors consisting of a type of content rendered, an application used to render the content, a user selection, a user history, and a device characteristic.

15. A method, comprising:
scrolling content rendered in a display device at a first positive speed;
receiving, at an optical sensor, image information of a user of an information handling device;
determining, using a processor, a focal point of user gaze with respect to the content rendered in the display device, the focal point being derived from the image information; and
adjusting the first positive speed for scrolling of the rendered content to a non-negative second speed based on the focal point of user gaze within the content rendered in the display device;
wherein the non-negative second speed is zero when the focal point exceeds a predetermined distance from a target.

16. The method of claim 15, wherein the non-negative second speed is larger than the first positive speed and results in an increased downward scrolling speed.

17. The method of claim 15, further comprising:
associating the focal point with the target of the display device; and
determining a distance between the focal point and the target;
wherein the adjusting is proportional to the distance.

18. The method of claim 15, wherein scrolling initially proceeds at a default rate determined via a factor selected from the group of factors consisting of a type of content rendered, an application used to render the content, a user selection, a user history, and a device characteristic.

19. The method of claim 15, wherein the adjusting is modified based on a factor selected from the group of factors consisting of a type of content rendered, an application used to render the content, a user selection, a user history, and a device characteristic.

20. The method of claim 19, wherein the type of content rendered is determined via an analysis of the content data.
